(19) United States
(12) Patent Application Publication
(10) Pub. No.: US 2005/0267653 A1
(43) Pub. Date: Dec. 1, 2005

(54) Method and system for processing and displaying real-time aircraft data

(76) Inventors: Patrick A. Matsushita, Mission Viejo, CA (US); Rolf P. Dietiker, Laguna Niguel, CA (US)

Correspondence Address: KLEIN, O'NEILL & SINGH, 2 PARK PLAZA, SUITE 510, IRVINE, CA, 92614, US

(21) Appl. No.: 10/969,560

(22) Filed: Oct. 20, 2004

Related U.S. Application Data
(60) Provisional application No. 60/563,345, filed on Apr. 19, 2004.

(51) Int. Cl. G06G 7/00

(52) U.S. Cl. 701/14

(57) ABSTRACT

A method and system for processing real-time data for an in transit aircraft is provided. The method includes, determining if the real-time data is current; extracting elements from the real-time data based on an entity that owns the aircraft; assigning a display code to display aircraft status; and providing a link to a display image allowing access to aircraft status using a computer network. An image code determines the type of image used to display aircraft status and a display code determines an image attribute for displaying the aircraft status. The system includes a processing module for determining if the real-time data is current; extracting elements from the real-time data based on an entity that owns the aircraft; assigning a display code to display aircraft status; and providing a link to a display image allowing access to aircraft status using a computer network.

### CROSS REFERENCE TO RELATED APPLICATION

This application claims priority under 35 U.S.C.§ 119(e)(1) to the following provisional patent applications: Ser. No. 60/563,345, filing date Apr. 19, 2004, the disclosure of which is incorporated herein by reference in its entirety.

### BACKGROUND OF THE INVENTION

1. Field of the Invention

The present invention relates to aircraft monitoring systems, and more particularly to a method and system for processing and displaying real-time aircraft navigation data.

2. Background

Air traffic today is complex and hectic. Modern business and personal travel air travel is rapidly increasing to meet the global nature of today's society. With such rapid increase in air travel and traffic, it has become key for airlines and organizations that manage air travel to be able to accurately predict, analyze and display an aircraft's status in real-time.

Conventional systems collect aircraft location/position data (may also be referred to as navigation data), for example, longitude and latitude of an airborne aircraft via satellites. An airplane communicates with one or more satellite and the data is sent to a satellite gateway. The gateway in turn provides the navigation data to one or more ground stations.

Conventional systems fail to efficiently process, analyze and/or display the raw ground station data at a central location or different locations that are functionally coupled to the central location. Therefore, there is a need for a method and system for processing navigation data.

### SUMMARY OF THE PRESENT INVENTION

In one aspect of the present invention, a method for processing real-time data for an in transit aircraft is provided. The method includes, determining if the real-time data is current; extracting elements from the real-time data based on an entity that owns the aircraft; assigning a display code to display aircraft status; and providing a link to a display image allowing access to aircraft status using a computer network. An image code determines the type of image used to display aircraft status and a display code determines an image attribute for displaying the aircraft status.

In yet another aspect, a system for processing real-time data for an in transit aircraft is provided. The system includes a processing module for determining if the real-time data is current; extracting elements from the real-time data based on an entity that owns the aircraft; assigning a display code to display aircraft status; and providing a link to a display image allowing access to aircraft status using a computer network.

In yet another aspect, the present invention, provides easily accessible user friendly aircraft status display that can be used at a central monitoring station or a remote station.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following figures:

FIG. 1A is a block diagram of a system for collecting navigation data for an aircraft;

FIG. 1B shows a block diagram of a computing system used according to one aspect of the present invention;

FIG. 1C shows the internal architecture of the computing system of the present invention;

FIG. 1D shows a block diagram with plural ground stations that are functionally coupled to a data center, according to one aspect of the present invention;

FIG. 1E shows a block diagram of a data processing module, according to one aspect of the present invention;

FIG. 2 is a process flow diagram for processing and displaying navigation data, according to one aspect of the present invention.

### DETAILED DESCRIPTION OF THE PREFERRED EMBODIMENTS

To facilitate an understanding of the preferred embodiment, the general architecture and operation of a system for collecting an aircraft's navigation data will be described. The specific architecture and operation of the preferred embodiments will then be described with reference to the general architecture.

Data Collection System:

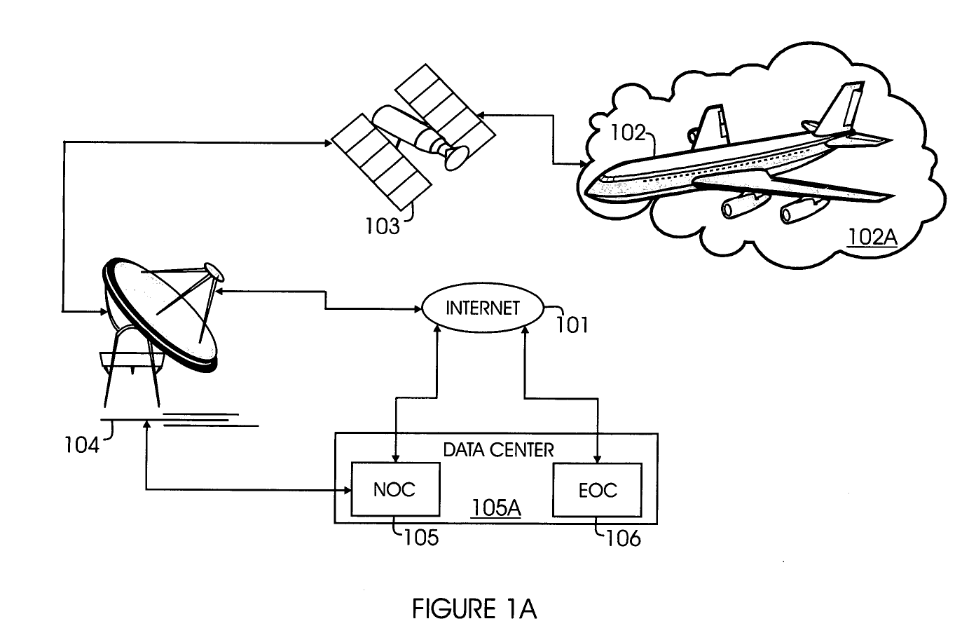

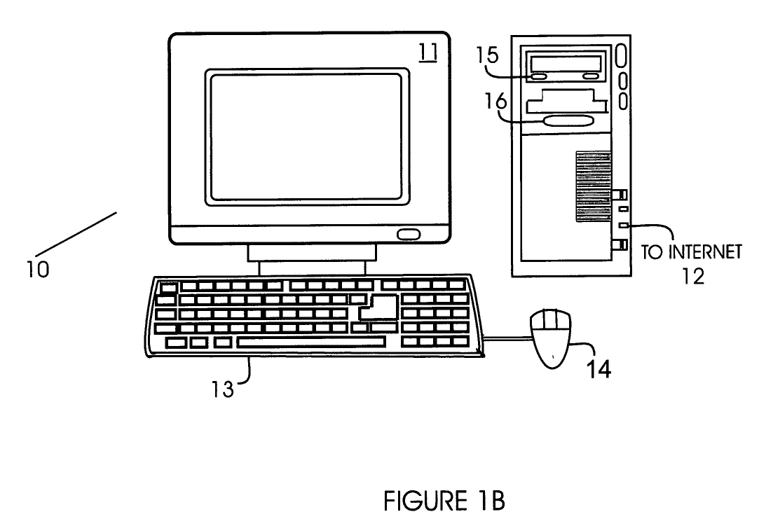

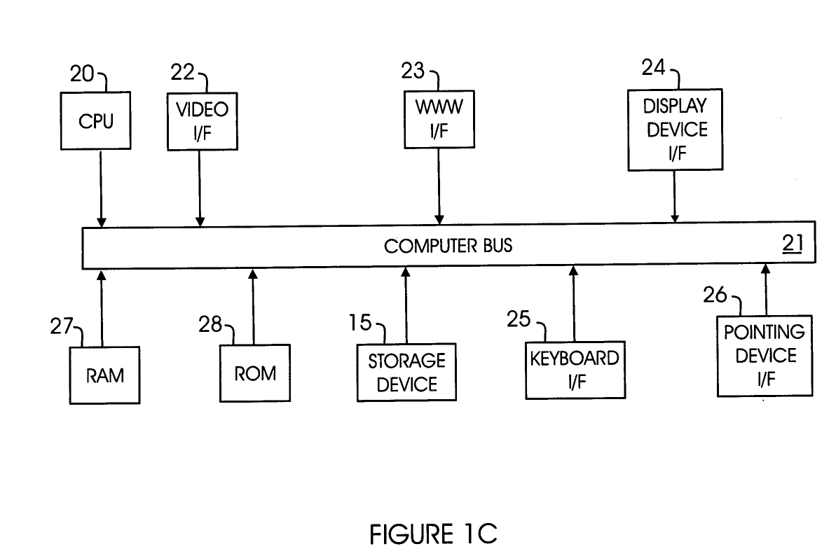

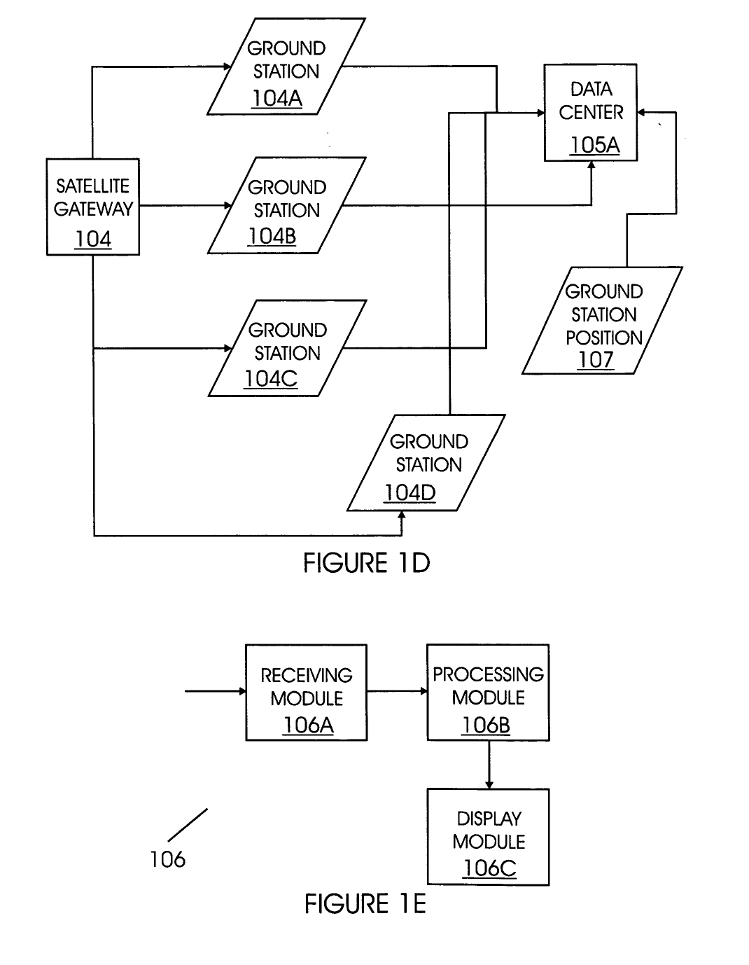

FIG. 1A shows a top-level block diagram for collecting real-time navigation data from an aircraft. An aircraft data center 102 located on aircraft 102A communicates with a satellite 103. Satellite 103 collects aircraft 102A's flight data and navigation data, which is then passed to satellite gateway 104, that is functionally, coupled to Internet 101 (described below) and/or a data center 105A.

Data center 105A includes a network operation center (“NOC”) 105 and an enterprise operation center (“EOC”) 106. Both NOC 105 and EOC 106 include at least a computing system for executing the computer-executable code, according to one aspect of the present invention. A description of a computing system used by NOC 105 and/or EOC 106 is provided below.

FIG. 1D shows another block diagram of the data collection system described above with respect to FIG. 1A. FIG. 1D shows plural ground stations 104A-104D that collect data from an aircraft while it is in transit. Ground stations 104A-104D are similar to satellite gateway 104. Ground station position data 107 includes the locations of plural ground stations 104A-104D and sent to data center 105A.

Data collected from the ground stations is processed by data center 105A, according to the adaptive aspects of the present invention. FIG. 1E shows a block diagram of a system used by EOC 106 in data center 106. EOC 106 includes a receiving module 106A that receives input navigation data from gateway 104. Processing module 106B processes the input data, based on the executable process steps of the present invention. Display module 106C displays the status of an aircraft based on the processing module 106B operations.

It is noteworthy that the invention is not limited to the structure of EOC 106 shown in FIG. 1E. A similar structure may be used in NOC 105. Furthermore, NOC 105 and EOC 106 may be an integral part of data center 105A to execute the process steps of the present invention. The modular components shown in various figures and described herein are intended to illustrate the adaptive aspects of the present invention and not to limit the present invention to any particular modular configuration.

Computing System:

FIG. 1B is a block diagram of a computing system for executing computer executable process steps according to one aspect of the present invention. FIG. 1B includes a host computer 10 and a monitor 11. Monitor 11 may be a CRT type, a LCD type, or any other type of color or monochrome display (or any other display device including a high definition television station).

Also provided with computer 10 are a keyboard 13 for entering data and user commands, and a pointing device 14 for processing objects displayed on monitor 11.

Computer 10 includes a computer-readable memory storage device 15 for storing readable data. Besides other programs, storage device 15 can store application programs including web browsers by which computer 10 connect to the Internet 101, and the computer-executable code according to the present invention.

According to one aspect of the present invention, computer 10 can also access computer-readable floppy disks storing data files, application program files, and computer executable process steps embodying the present invention or the like via a floppy disk drive 16. A CD-ROM, or CD R/W (read/write) interface (not shown) may also be provided with computer 10 to access application program files, and data files stored on a CD-ROM.

A modem, an integrated services digital network (ISDN) connection, or the like also provide computer 10 with an Internet connection 12 to the World Wide Web (WWW). The Internet connection 12 allows computer 10 to download data files, application program files and computer-executable process steps embodying the present invention from Internet 101.

It is noteworthy that the present invention is not limited to the FIG. 1B architecture. For example, notebook or laptop computers, handheld devices, set-top boxes or any other system capable of running computer-executable process steps, as described below, may be used to implement the various aspects of the present invention.

FIG. 1C is a block diagram showing the internal functional architecture of computer 10. As shown in FIG. 1C, computer 10 includes a central processing unit (“CPU”) 20 for executing computer-executable process steps and interfaces with a computer bus 21. Also shown in FIG. 1C are a video interface 22, a WWW interface 23, a display device interface 24, a keyboard interface 25, a pointing device interface 26, and storage device 15.

As described above, storage device 15 stores operating system program files, application program files, web browsers, and other files. Some of these files are stored using an installation program. For example, CPU 20 executes computer-executable process steps of an installation program so that CPU 20 can properly execute the application program.

Random access memory (“RAM”) 27 also interfaces to computer bus 21 to provide CPU 20 with access to memory storage. When executing stored computer-executable process steps from storage device 15 (or other storage media such as floppy disk 16 or WWW connection 12), CPU 20 stores and executes the process steps out of RAM 27.

Read only memory (“ROM”) 28 is provided to store invariant instruction sequences such as start-up instruction sequences or basic input/output operating system (BIOS) sequences for operation of keyboard 13.

Computer-executable process steps, according to one aspect of the present invention may be performed using the Internet 101. The following provides a brief description of the Internet.

Internet 101:

The Internet connects plural computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (XML) as published by W3C Consortium, Version 1, Second Edition, October 2000, ©W3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online or CompuServe, or via an Internet Service Provider, e.g., Earthlink. The web browser may run on any computer connected to the Internet. Currently, various browsers are available of which two prominent browsers are Netscape Navigator and Microsoft Internet Explorer.

The Web Browser receives and sends requests to a web server and acquires information from the WWW. A web server is a program that, upon receipt of a request, sends the requested data to the requesting user.

A standard naming convention known as Uniform Resource Locator (“URL”) has been adopted to represent hypermedia links and links to network services. Most files or services can be represented with a URL. URLs also enable two programs on two separate computers to communicate with each other through simple object access protocol (“SOAP”), extensible markup language (“XML”), and other protocols published by the W3C consortium, incorporated herein by reference in its entirety.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP). It is noteworthy that the invention is not limited to standard WWW or W3C protocols for server access and information exchange.

Process Flow:

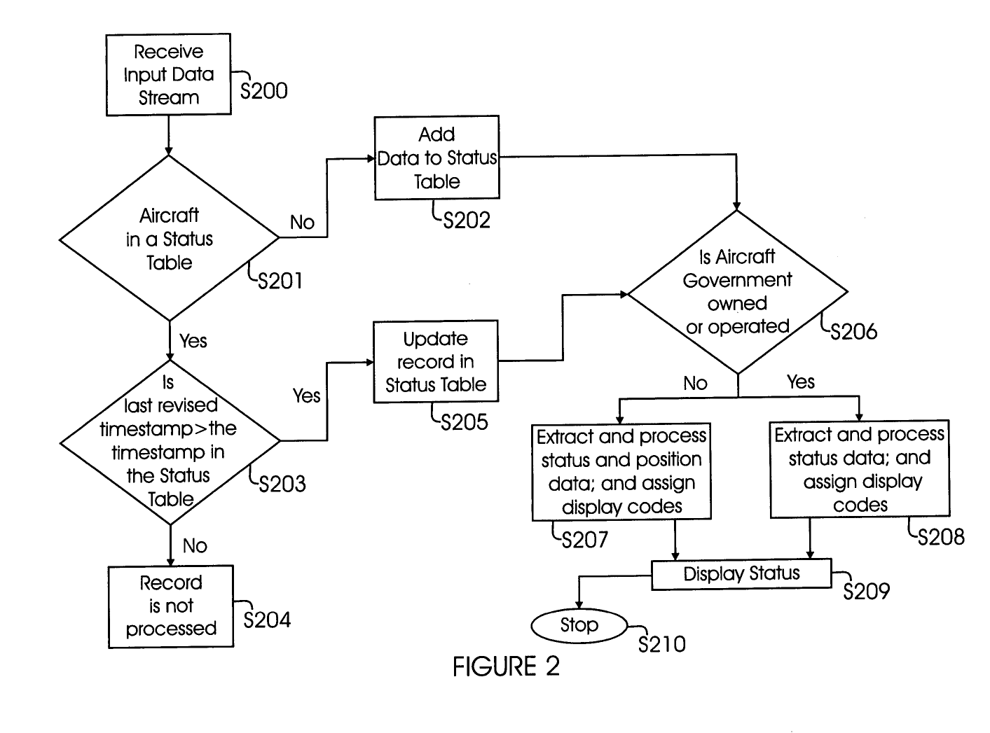

FIG. 2 shows a flow diagram of computer executable process steps for processing real-time navigation data received from at least one ground station, according to one aspect of the present invention. Raw data is received from plural ground stations, useful location and status information is extracted, a display code is assigned that controls how data is displayed, and a web address may be input for each displayed image, according to one aspect of the present invention.

Turning now in detail to FIG. 2, in step S200, input navigation data for aircraft 102A is received from one or more ground stations (104A-104D) by data center 105A. Table I below provides a description of the collected data.

TABLE I

| Input Data | Description |
|---|---|
| AIRCRAFT_ID | Aircraft Identifier that identifies |
| | aircraft 102A whose |
| | status is being monitored |
| ANTENNA_TYPE_ID | Identifies the type of antenna on |
| | aircraft 102A that communicates |
| | with satellite 103 |
| MODEL_TYPE_ID | Aircraft 102A Model Type |
| MODEL_DESC | Aircraft 102A Model Description |
| NAME | Aircraft 102A Name |
| FAA_TAIL_NUMBER | Aircraft 102A's unique tail number, |
| | assigned by the Federal Aviation |
| | Authority |
| ICAO | A field that identifies the airlines, |
| | if applicable |
| CUSTOMER_TYPE | Identifies the type of customer, i.e. |
| | commercial or government |
| ROUTER_IP | IP address for the router on Aircraft |
| | 102A |
| E_SERVER_IP | Physical server address on Aircraft |
| | 102A |
| OWNER | Aircraft 102A owner |
| ALTITUDE_POS_ERR | Altitude position error |
| FL_XPDR_ID | Forward link transponder on the |
| | aircraft |
| FL_XPDR_NAME | Forward link transponder name |
| RLD_BLOCK_HW_ID | Return link to Aircraft 102A |
| SATELLITE_ID | Identity of Satellite 103 |
| SATELLITE_NAME | Name of Satellite 103 |
| RLD_CHANNEL_NUM | Return link channel number |
| RESTRICT_ZONE_ENABLE | Geographical zone for restricted data |
| | transmission |
| TRANMIT_ZONE_ENABLE | Geographical zone where data |
| | transmission is enabled |
| LAST_REV_DTTM | Time stamp for the last revision |
| ALTITUDE LATITUDE | Real-time latitude of aircraft 102A |
| LONGITUDE | Real-time longitude of aircraft 102A |
| GROUND SPEED | Ground speed of aircraft 102A at the |
| | time data is collected |
| VERTICAL SPEED | Vertical speed of aircraft 102A |
| LOAD_DTM | Last time data was updated |
| SOURCE_LOCATION | Location of the data source |
| SOURCE_SW_VERSION | Software version of the data |

In step S201, the process evaluates whether the aircraft 102A status is available in an existing status table. The status table (described below with respect to Table ₁₁) is stored in data center 105A or at location remote to data center 105A. If aircraft 102A status is not available, then in step S202, the position data is added to an aircraft status table and the process moves to step S206.

If aircraft 102A status table is available, then in step S203, the process determines if the revised timestamp for the received data is greater than the timestamp in the existing status table. If not, then the data is not processed in step S204. If the timestamp is greater than the previous value, then in step S205, the process updates the record and the process moves to step S206.

In step S206, the process determines if aircraft 102A is owned and/or operated by a government entity. If yes, then in step S208, the status data of aircraft 102A is extracted and processed. Also, any other field that is specified by the government agency is extracted and processed.

An image code is added that specifies the type of image used for displaying the status of aircraft 102A. A display code is also assigned to the data that defines the attributes of the image. The value of the code determines how the image will be displayed. For example, a “flashing” airplane image of any color may be used on a display screen 11 to show the status of aircraft 102A. A URL may also be added to the displayed image, which allows remote access to the status information using Internet 101.

If the aircraft is not owned and/or operated by a government entity, then in step S207, position and status information is extracted and processed from the input data. Again, an image and display code is assigned for the extracted data as described above. A URL address may be added for the displayed image, allowing access to status information via Internet 101. The tail number of aircraft 102A is also verified from a source that is independent from the input data source. A description for aircraft 102A is added with the flight number, if applicable, and a time stamp is added that denotes when data was updated.

Furthermore, the bandwidth of the transponder (not shown) on aircraft 102A is set. This optimizes data collection from aircraft 102A. The process also specifies the first time communication was established between the ground station and aircraft 102A. The status table also provides, airport departure code, airport arrival code, aircraft 102A departure time and arrival time, as shown below with respect to Table II.

In step S209, a display application displays the status of aircraft 102A based on the assigned display code and image code. In one aspect, a pointing device (a mouse) 14 is used to click on an icon or an object to display the status of the aircraft 102A. Various fields may be displayed, as described below in Table II. The display application may be a three-dimensional program that is updated every time position information is received and updated. Thereafter, the process ends in step S210.

Table II below describes plural fields used by the process flow diagram described above to display the status of aircraft 102A.

TABLE II

| | |
|---|---|
| PROCESSED DATA | DESCRIPTION |

| | |
|---|---|
| OBJECT_CD | Object code identifier for displaying the |
| | status of aircraft 102A |
| DESCRIPTION | Aircraft 102A description |
| TIME_STAMP | The time a record is loaded into data |
| | center 105A |
| OBJ_TYPE_CD | This field signifies the type of flight |
| TAIL_NUMBER | Aircraft 102A tail number verified from a |
| | source independent of the input data |
| | source |
| CARRIER_CD | This field identifies the owner of |
| | aircraft 102A |
| FLIGH_NBR | This field specifies the flight number, |
| | if any |
| AIRCRAFT_TYPE | This field specifies the type of aircraft |
| DEP_AIRPORT | This field identifies the airport from |
| | where aircraft 102A departed |
| ARR_AIRPORT | This field identifies the arrival airport |
| | for aircraft 102A |
| DEPARTURE_DATE | This field specifies the departure date |
| | for aircraft 102A |
| DEPART_TIME | This field specifies the departure time |
| | for aircraft 102A |
| ARRIVAL_TIME | This field specifies arrival time for |
| | aircraft 102A |
| ALTITUDE/LATITUDE | This field specifies the latitude for |
| | aircraft 102A |
| LONGITUDE | This field specifies the longitude for |
| | aircraft 102A |
| SATELLITE_ID | This field identifies satellite 103 |
| BANDWIDTH | This field identifies the bandwidth of |
| | the transponder on aircraft 102A |
| LINK_ESTABLISH | This field denotes the first time |
| | communication was established between a |
| | ground station and aircraft 102A |
| SYMBOL_IMAGE | This field specifies the image used for |
| | providing status for aircraft 102A |
| SYMBOL_STATUS | This field provides the status on the |
| | symbol |
| HYP_LINK | This provides a URL link to the image |
| | that is used to display the status of |
| | aircraft 102A |
| DISPLAY_CODE | This code specifies how the image is |
| | displayed to show the status of aircraft |
| | 102A |
| TRACK_COLOR | This field is used to specify the color |
| | of the flight tracking image |
| TRACK_THICKNESS | This field is used to specify the |
| | thickness of the image tracking a flight |
| TRACK_TYPE | This field is used to specify the type of |
| | line (for example, solid, dotted, or |
| | dashed) for flight tracking |
| NUM_USER | This field specifies the number of users |
| | that are using Internet services on |
| | aircraft 102A at a given time |
| LAST_REVD_DTTM | This provides a time stamp for status |
| | update |
| LOCATION | This field specifies the physical |
| | location of data source |
| SW_VERSION | This field specifies the software version |
| | of the program for the processed output |
| | data |

In one aspect of the present invention, a central monitoring station can use the processed data and status information to track the progress of a flight. This status may also be viewed and used by an airline or any other entity that needs to observe and monitor real-time data. The status is available via Internet 101 and hence provides the flexibility to deal with any emergencies involving aircraft 102A. The real-time data may also be made available to passengers on aircraft 102A via the web link. Furthermore, the various fields in Table II may be customized for different customers and entities. For example, specific display codes may be assigned for individual airlines.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

1. A method for processing real-time data for an in transit aircraft, comprising:
determining if the real-time data is current;
extracting elements from the real-time data based on an entity that owns the aircraft;
assigning a display code to display aircraft status; and
providing a link to a display image allowing access to aircraft status using a computer network.

2. The method of claim 1, determining if the aircraft owner and/or operator is a government entity.

3. The method of claim 2, extracting status information for a government aircraft.

4. The method of claim 1, extracting status and position information for a non-government aircraft.

5. The method of claim 1, wherein an image code determines the type of image used to display aircraft status.

6. The method of claim 5, wherein a display code determines an image attribute for displaying the aircraft status.

7. A computer-readable medium storing computer-executable process steps for a process for use in a computer system for processing real-time data for an in transit aircraft, comprising:
executable code for determining if the real-time data is current;
executable code for extracting elements from the real-time data based on an entity that owns the aircraft;
executable code for assigning a display code to display aircraft status; and
executable code for providing a link to a display image allowing access to aircraft status using a computer network.

8. The computer-readable medium of claim 7, further comprising: executable code for determining if aircraft owner and/or operator is a government entity.

9. The computer-readable medium of claim 8, further comprising:
executable code for extracting status information for a government aircraft.

10. The computer-readable medium of claim 7, further comprising:
executable code for extracting status and position information for a non-government aircraft.

11. The computer-readable medium of claim 7, wherein an image code determines the type of image used to display aircraft status.

12. The computer-readable medium of claim 11, wherein a display code determines an image attribute for displaying the aircraft status.

13. A system for processing real-time data for an in transit aircraft, comprising:
processing module for determining if the real-time data is current; extracting elements from the real-time data based on an entity that owns the aircraft; assigning a display code to display aircraft status; and providing a link to a display image allowing access to aircraft status using a computer network.
